(19) United States
(12) Patent Application Publication
(10) Pub. No.: US 2025/0159613 A1
(43) Pub. Date: May 15, 2025

(54) TERMINAL CONTROL METHOD AND APPARATUS, COMMUNICATION DEVICE, AND STORAGE MEDIUM

(71) Applicant: Beijing Xiaomi Mobile Software Co., Ltd., Beijing (CN)

(72) Inventors: Zhongbo WANG, Beijing (CN); Shuai LIANG, Beijing (CN)

(21) Appl. No.: 18/834,004

(22) PCT Filed: Jun. 24, 2022
(86) PCT No.: PCT/CN2022/101264

§ 371 Date: Jul. 29, 2024

(51) Int. Cl. H04W 52/02; H02J 50/40

(52) U.S. Cl. CPC H04W 52/0261; H02J 50/40

(57) ABSTRACT

A terminal control method includes: obtaining multiple terminal functions supported by a target driver module in a terminal; determining, in response to detection of an operational command indicating at least two terminal functions, a priority relationship of the at least two terminal functions; and executing, based on the priority relationship, one terminal function out of the at least two terminal functions through the target driver module.

### CROSS REFERENCE TO RELATED APPLICATIONS

The present disclosure is the U.S. national phase application of International Application No. PCT/CN2022/101264 filed on Jun. 24, 2022, the content of which is incorporated herein by reference in its entirety.

### TECHNICAL FIELD

The present disclosure relates to, but is not limited to, the field of electronic device technology, in particular to a terminal control method and apparatus, a communication device, and a storage medium.

### BACKGROUND

In the related art, a terminal often has independent driver modules to be arranged for scenarios where different functions are achieved. For example, to provide a vibration prompt function for mobile phones, a dedicated motor driver module is employed, and to provide a wireless reverse charging function of mobile phones, a wireless reverse charging driver module is employed.

### SUMMARY

A first aspect of the present disclosure provides a terminal control method. The method includes: obtaining multiple terminal functions supported by a target driver module in a terminal; determining, in response to detection of an operational command indicating at least two terminal functions, a priority relationship of the at least two terminal functions; and executing, based on the priority relationship, one terminal function out of the at least two terminal functions through the target driver module.

A second aspect of the present disclosure provides a terminal control apparatus. The apparatus includes: an obtaining unit configured to obtain multiple terminal functions supported by a target driver module in a terminal; a determination unit configured to determine, in response to detection of an operational command indicating at least two terminal functions, a priority relationship of the at least two terminal functions; and an execution unit configured to execute, based on the priority relationship, one terminal function out of the at least two terminal functions through the target driver module.

A third aspect of the present disclosure provides a communication device including a processor, a memory, and an executable program stored in the memory that can be executed by the processor. When executable program is executed by the processor, the terminal control method provided in the first aspect is caused to be implemented.

A fourth aspect of the present disclosure provides a computer storage medium having an executable program stored thereon, which when executed by a processor, the terminal control method provided in the first aspect is caused to be implemented.

It should be understood that the general description in the above and the detailed description in the following are only illustrative and explanatory, and do not limit the present disclosure.

### BRIEF DESCRIPTION OF THE DRAWINGS

The drawings, which are incorporated in and constitute a portion of this specification, illustrate embodiments consistent with the present disclosure and serve together with the specification to explain principles of the present disclosure.

FIG. 1 is a schematic diagram of a structure of a wireless communication system according to embodiments of the present disclosure;

FIG. 2 is a flowchart of a terminal control method according to embodiments of the present disclosure;

FIG. 3 is a schematic diagram of a structure of a terminal control architecture in the related art;

FIG. 4 is a flowchart of a terminal control method according to embodiments of the present disclosure;

FIG. 5 is a flowchart of a terminal control method according to embodiments of the present disclosure;

FIG. 6 is a schematic diagram of a structure of a terminal control architecture according to embodiments of the present disclosure;

FIG. 7 is a flowchart of a terminal control method according to embodiments of the present disclosure;

FIG. 8 is a flowchart of a terminal control method according to embodiments of the present disclosure;

FIG. 9 is a schematic diagram of a structure of a terminal control apparatus according to embodiments of the present disclosure; and

FIG. 10 is a schematic diagram of a structure of a terminal according to embodiments of the present disclosure.

### DETAILED DESCRIPTION

Detailed explanations of exemplary embodiments will be provided herein, with examples being illustrated in the drawings. The same reference numerals in different drawings represent the same or similar elements when the following description refers to the drawings, unless otherwise indicated. The implementations described in the following exemplary embodiments do not represent all implementations consistent with the present disclosure, instead, they are only examples of devices and methods consistent with some aspects of embodiments of the present disclosure.

The terms used in embodiments of the present disclosure are for the purpose of description of specific embodiments only, and are not intended to limit the embodiments of the present disclosure. Singular forms such as “a”, “said”, and “the” used in the present disclosure are also intended to include plural forms, unless other meanings are clearly indicated in the context. It should also be understood that the term “and/or” used in the present disclosure refers to and includes any or all possible combinations of one or more listed items related.

It should be understood that although terms such as first, second, and third may be used to describe various information in embodiments of the present disclosure, such information should not be limited to these terms, which are only used to distinguish information of the same type from each other. For example, without departing from the scope of the present disclosure, the first information can also be referred to as the second information, and similarly, the second information can also be referred to as the first information. The word “if” used herein can be interpreted as “when” or “while” or “in response to determination that”, depending on the context.

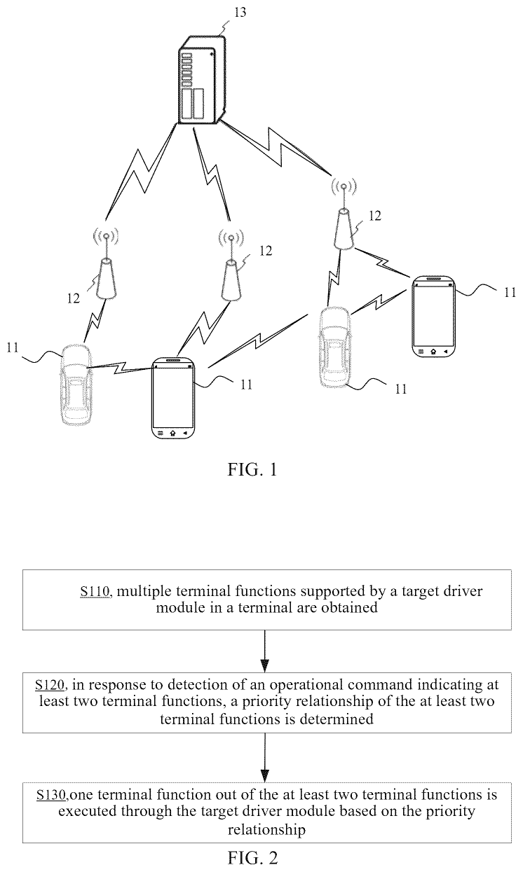

Reference is made to FIG. 1, which illustrates a schematic diagram of a structure of a wireless communication system provided by embodiments of the present disclosure. As shown in FIG. 1, the wireless communication system is a communication system based on cellular mobile communication technology, which can include several terminals 11 and several access devices 12.

The terminal 11 can be equipment that provides voice and/or data connectivity to a user. The terminal 11 can communicate with one or more core networks via a Radio Access Network (RAN). The terminal 11 can be an IoT (Internet of Things) terminal, for example, a sensor device, a mobile phone (or a “cellular” phone), and a computer with IoT terminals, such as fixed, portable, pocket, handheld, computer built-in, or vehicle mounted devices. For example, stations (STA), subscriber units, subscriber stations, mobile stations, mobiles, remote stations, access points, remote terminals, access terminals, user terminals, user agents, user devices or terminals. Alternatively, the terminal 11 can also be a device for unmanned aerial vehicles. Alternatively, the terminal 11 can also be an onboard device, such as a trip computer with wireless communication ability or wireless communication devices connected to an external trip computer. Alternatively, the terminal 11 can also be a roadside device, such as a street light, a signal light, or other roadside devices with wireless communication ability.

The access device 12 can be a network side device in the wireless communication system. The wireless communication system can be the 4th generation (4G) mobile communication system, also known as Long Term Evolution (LTE) system. Alternatively, the wireless communication system can also be the 5th generation (5G) system, also known as New Radio system or 5G NR system. Alternatively, the wireless communication system can also be the next generation system following 5G system. The access network in 5G system can be referred to as the New Generation-Radio Access Network (NG-RAN). Alternatively, an MTC system.

The access device 12 can be the Evolved Node B (eNB) employed in 4G system. Alternatively, the access device 12 can also be the next Generation Node B (gNB) constructed in a centralized and distributed architecture in 5G system. When constructed in the centralized and distributed architecture, the access device 12 usually includes a central unit (CU) and at least two distributed units (DUs). The central unit is provided with a protocol stack consisting of the Packet Data Convergence Protocol (PDCP) layer, the Radio Link Control (RLC) layer, and the Medium Access Control (MAC) layer. The distributed unit is provided with a protocol stack of the Physical (PHY) layer. Specific implementations of the access device 12 are not limited in embodiments of the present disclosure.

A wireless connection can be established between the access device 12 and the terminal 11 via a wireless air interface. In different implementations, the wireless air interface is based on the 4th generation (4G) mobile communication network technology standard. Alternatively, the wireless air interface is based on the 5th generation (5G) mobile communication network technology standard, for example, the wireless air interface is the New Radio. Alternatively, the wireless air interface can also be a wireless air interface based on the next generation mobile communication network technology standard following 5G.

In some embodiments, the wireless communication system described above can also include a network management device 13. Some of access devices 12 are respectively connected to the network management device 13. The network management device 13 can be a core network device in the wireless communication system, for example, the network management device 13 can be the Mobility Management Entity (MME) in the Evolved Packet Core (EPC). Alternatively, the network management device can also be other core network devices, such as the Service GateWay (SGW), the Public Data Network GateWay (PGW), the Policy and Charging Rules Function (PCRF), or the Home Subscriber Server (HSS). Implementations of the network management device 13 are not limited in embodiments of the present disclosure.

In most cases, the wireless reverse charging driver module is infrequently used, and the using of different chips is unbalance, leading to the waste of hardware resources. Due to the fact that different functions of the terminal are controlled through different chips in the related art, the chips are often not fully utilized, some of the chips for achieving some functions are less frequently used, and the hardware resources are wasted, which not only leads to an increase in chip costs but also occupies a larger area of the circuit board layout.

As shown in FIG. 2, embodiments of the present disclosure provide a terminal control method, which can include following steps.

In step S110, multiple terminal functions supported by a target driver module in a terminal are obtained.

In step S120, in response to detection of an operational command indicating at least two terminal functions, a priority relationship of the at least two terminal functions is determined.

In step S130, one terminal function out of the at least two terminal functions is executed through the target driver module based on the priority relationship.

In some embodiments, the terminal can be any terminal that executes the terminal function through the driver module. For example, the terminal can be devices such as mobile phones, computers, tablets, smartwatches, or can be smart home devices. In some embodiments, the terminal function can be the function that the terminal needs to realize in a respective working scenario. For example, the terminal function can include functions of the mobile phone such as ringing, vibration, Bluetooth, data exchange (On The Go, OTG), forward or reverse charging, etc.

In the present disclosure, the forward charging can mean that the terminal is charged by other devices, and the reverse charging can mean that the terminal supplies power to other devices. For example, the reverse charging can include wireless reverse charging.

In some embodiments, the target driver module can be the driver module used in a terminal, which is configured to execute the multiple terminal functions. For example, the driver module can be a Power Management Integrated Circuit Chip (PMIC) or a switching power supply Boost. For example, the target driver module can be the chip PM8350B, etc.

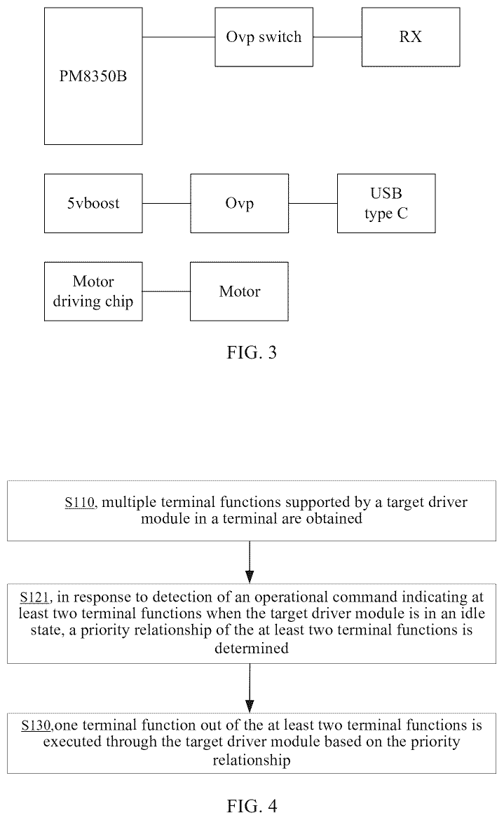

In the related art, as shown in FIG. 3, different terminal functions are executed through different chips. For example, the chip PM8350B is connected to the over voltage protection (Ovp) switch to execute the wireless reverse charging function (RX represents a receiver), the 5V power supply Boost is connected to the Ovp switch to execute the OTG function via the Universal Serial Bus (USB) or USB type-c, and a motor driver chip controls a motor to execute the vibration function.

In the related art, the respective chip can only execute single terminal function, and usually a large amount of hardware resources is wasted. Also, there are often hardware control logic exclusions or power consumption issues between multiple terminal functions, making it impossible to execute two or more terminal functions simultaneously through one target driver module. Therefore, when the multiple terminal functions are supported by one driver module, it is necessary to set the execution strategy of the target driver module.

In some embodiments, the operational command can be an operational command instructed by a user, or an operational command generated by the terminal based on user operations or other information received. For example, when receiving a phone call, the terminal generates the operational command indicating the execution of the vibration function for reminder.

In some embodiments, the target driver module can be the driver module originally used by the terminal to execute one of the terminal functions. By connecting the hardware control circuits corresponding to other terminal functions to the target driver module, multiple terminal functions can be executed through the target driver module. For example, control circuits corresponding to multiple terminal functions can be connected in parallel.

In some embodiments, the multiple terminal functions supported by the target driver module in the terminal are obtained, which mean that association information between the driver module and the supported terminal functions that is stored in the terminal or server can be obtained. In some embodiments, the association information can record each terminal function and the driver module used to execute the terminal function, and/or record each driver module and the terminal function(s) supported by the driver module.

In some embodiments, the operational command indicating at least two terminal functions can be an operational command indicating at least two terminal functions supported by the target driver module. In some embodiments, the operational command indicating at least two terminal functions can be one single operational command. For example, the operational command can be an operational command indicating that the wireless reverse charging function is activated and the terminal (or the screen of the terminal) vibrates to prompt the user.

In some embodiments, the operational command indicating at least two terminal functions can also be at least two operational commands. For example, the operational command can be two operational commands respectively indicating that the wireless reverse charging function is activated and the vibration prompt function is activated.

In some embodiments, the operational command indicating at least two terminal functions includes at least two operational commands, and the step S120, where an operational command indicating at least two terminal functions is detected, can include detecting the operational command indicating at least two terminal functions within a preset time window. For example, after the operational command indicating a first terminal function is detected, the operational command indicating a second terminal function or indicating multiple terminal functions other than the first terminal function is detected within a preset time window.

In some embodiments, the preset time window can be determined based on the type of the terminal function. In some embodiments, an average duration for executing the first terminal function can be determined based on the type of the first terminal function, and the preset time window can be determined based on the average duration. For example, the preset time window can be determined as 1/10 or 1/20 of the average duration.

In some embodiments, that the operational command indicating at least two terminal functions is detected within the preset time window can include detecting the operational command indicating at least two terminal functions within the preset time window when the target driver module is in an idle state.

In some embodiments, the average duration determined based on the type of the first terminal function is 1 minute, and the preset time window can be 3 seconds.

In some embodiments, the operational command indicating at least two terminal functions includes at least two operational commands, and the step S120, where an operational command indicating at least two terminal functions is detected, can further include detecting the operational command indicating other terminal functions different from the first terminal function during the execution of the first terminal function by the target driver module.

In some embodiments, an average duration for executing the first terminal function can be determined based on the historical execution records of the execution of the first terminal function by the terminal, and/or based on the historical execution records of multiple associated terminal functions that belong to the same type as the first terminal function.

In some embodiments, when the first terminal function is wireless reverse charging, the historical execution records of multiple associated terminal functions such as wireless reverse charging, wireless forward charging, wired charging, etc., can be obtained. Multiple execution duration corresponding to the multiple terminal functions can be determined based on the historical execution records, and the average duration for executing the first terminal function can be determined based on the multiple execution duration.

In some embodiments, the priority relationship of the at least two terminal functions can be the priority of each terminal function out of the at least two terminal functions, or the priority order of the at least two terminal functions. For example, the first priority of the first terminal function, the second priority of the second terminal function, etc. can be determined.

In some embodiments, the priority relationship of the at least two terminal functions can be determined based on the current working scenario of the terminal. In some embodiments, the priority relationship of the at least two terminal functions is determined based on the current resource occupancy rate of the terminal.

In some embodiments, when the current resource occupancy rate of the terminal is high, for example, greater than a preset threshold value, the terminal function with the lowest resource occupancy rate out of the at least two terminal functions is determined to be the terminal function with the highest priority. In this way, the matching between the terminal function to be executed and the working condition of the terminal can be improved, thereby enhancing the intelligence of the implementation of the terminal function.

In some embodiments, the step S130 can include determining the terminal function with the highest priority out of the at least two terminal functions based on the priority relationship, and executing the terminal function with the highest priority through the target driver module.

In some embodiments, executing the terminal function with the highest priority through the target driver module can include: in response to inconsistency between the terminal function with the highest priority and the terminal function currently being executed by the target driver module, stopping the execution of the current terminal function, and executing the terminal function with the highest priority through the target driver module.

In some embodiments, the step S120 can include: in a case where the operational command indicating at least two terminal functions is detected when the target driver module is executing the current terminal function, determining the priority relationship of the at least two terminal functions and the current terminal function being executed. For example, the terminal function with the highest priority out of the at least two terminal functions can be determined, and then the priority relationship between the terminal function with the highest priority and the current terminal function is determined.

In some embodiments, the step S130 can include: determining based on the priority relationship whether the terminal function with the highest priority is the current terminal function, in response to determination that the terminal function with the highest priority is the current terminal function, continuing the execution of the current terminal function, and in response to determination that the terminal function with the highest priority is not the current terminal function, stopping the execution of the current terminal function and executing the terminal function with the highest priority through the target driver module.

In this way, the target driver module can be used to support the execution of multiple terminal functions, reducing the hardware resource waste caused by providing independent driver modules for multiple terminal functions, improving the utilization rate of the target driver module, and reducing the layout area of the circuit board. On this basis, when there are multiple terminal functions waiting to be executed at the same time, one of the multiple terminal functions can be executed first based on the priority relationship, improving the intelligence of the target driver module, so that the execution of terminal functions can be allocated reasonably, and the terminal function conflicts can be reduced, which will result in low availability of the terminal.

As shown in FIG. 4, embodiments of the present disclosure provide a terminal control method, which can include following steps.

In step S110, multiple terminal functions supported by a target driver module in a terminal are obtained.

In step S121, in response to detection of an operational command indicating at least two terminal functions when the target driver module is in an idle state, a priority relationship of the at least two terminal functions is determined.

In step S130, one terminal function out of the at least two terminal functions is executed through the target driver module based on the priority relationship.

In some embodiments, the target driver module is in an idle state, which means that the target driver module does not execute any terminal function, or which means that the target driver module is in a state where any terminal function can be executed. For example, if the target driver module is working, for example, the target driver module is supplying power to certain components, it can be considered that the target driver module is in an idle state, because the target driver module can still perform any of the terminal functions currently.

In some embodiments, the step S121 can include: when the target driver module is in an idle state, if an operational command indicating at least two terminal functions is detected within a preset time window, determining the priority relationship of the at least two terminal functions. For example, when the target driver module is in an idle state, if a first operational command indicating a first terminal function is detected, and a second operational command indicating a second terminal function is detected within a preset time window, the priority relationship between the at least two terminal functions is determined.

In some embodiments, when the target driver module is in an idle state, if the first operational command indicating the first terminal function is detected, the first terminal function can be temporarily not executed, and then if the second operational command indicating the second terminal function is detected within the preset time window, the priority relationship of the at least two terminal functions is determined, and one of the terminal functions is executed through the target driver module based on the priority relationship.

In some embodiments, when the target driver module is in an idle state, if the first operational command indicating the first terminal function is detected, the first terminal function can be temporarily not executed, and then if the second operational command indicating the second terminal function is not detected within the preset time window, the first terminal function can be executed through the target driver module.

In some embodiments, the step S130 can include: determining a target terminal function with the highest priority based on the priority relationship, and determining whether the target driver module has activated a terminal function other than the target terminal function. Then the step S130 can include: if the target driver module has activated a terminal function other than the target terminal function, stopping the terminal function other than the target terminal function and executing the target terminal function through the target driver module, and if the target driver module does not activate the terminal function other than the target terminal function, disconnecting the control circuit corresponding to the terminal function other than the target terminal function from the target driver module, and executing the target terminal function through the target driver module.

In this way, the priority of multiple terminal functions to be executed can be determined in the idle state of the target driver module, thereby improving the accuracy and intelligence when the target driver module executes terminal functions, and reducing terminal function conflicts, which will result in the malfunction of the target driver module.

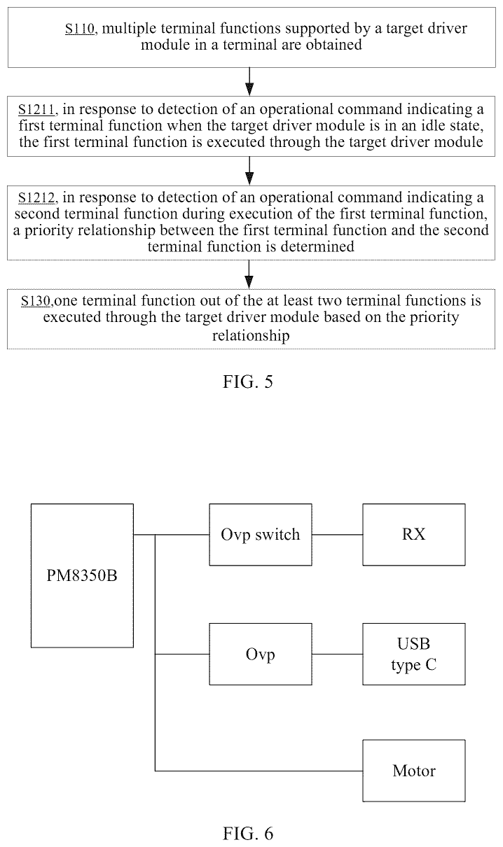

As shown in FIG. 5, embodiments of the present disclosure provide a terminal control method, which can include following steps.

In step S110, multiple terminal functions supported by a target driver module in a terminal are obtained.

In step S1211, in response to detection of an operational command indicating a first terminal function when the target driver module is in an idle state, the first terminal function is executed through the target driver module.

In step S1212, in response to detection of an operational command indicating a second terminal function during execution of the first terminal function, a priority relationship between the first terminal function and the second terminal function is determined.

In step S130, one terminal function out of the at least two terminal functions is executed through the target driver module based on the priority relationship.

In some embodiments, the first terminal function is different from the second terminal function. For example, the first terminal function can be the wireless reverse charging function, and the second terminal function can be the vibration function, etc.

In some embodiments, if a first operational command indicating the first terminal function is detected, the first terminal function is executed through the target driver module, which can include: if a first operational command indicating the first terminal function is detected, determining whether a second operational command is detected within a preset time window, and if no second operational commands are detected within the preset time window, executing the first terminal function through the target driver module.

In some embodiments, the method can further include: if a first operational command indicating the first terminal function is detected, determining whether a second operational command indicating the second terminal function is detected within a preset time window, and if a second operational command is detected within the preset time window, determining the priority relationship between the first terminal function and the second terminal function.

In some embodiments, the step S1212 can include: during the execution of the first terminal function, if a second operational command indicating the second terminal function is detected, determining the remaining duration for completing the execution of the first terminal function execution, and if the remaining duration exceeds a preset threshold, determining the priority relationship between the first terminal function and the second terminal function.

In some embodiments, in the case where the first terminal function is the wireless reverse charging, determining the remaining duration for completing the execution of the first terminal function can include estimating the remaining duration for completing the wireless reverse charging. If the remaining duration is higher than the preset threshold, which indicates that the execution of the first terminal function requires a longer time, then the second terminal function needs to be executed first based on the priority relationship.

In some embodiments, the method can further include: during the execution of the first terminal function, if a second operational command indicating the second terminal function is detected, determining the remaining duration for completing the execution of the first terminal function. If the remaining duration is lower than or equal to the preset threshold, the second terminal function will be executed through the target driver module after the execution of the first terminal function is completed or after the remaining duration.

In this way, during the execution process of the terminal function by the target driver module, if other terminal functions need to be executed, the priority relationship is used to determine whether to switch to other terminal functions. As a result, the flexibility of the target driver module can be further improved, and those more important terminal functions will be executed first when there are conflicts among multiple terminal functions.

In some embodiments, the step S130 can include following steps:
in response to the first priority of the first terminal function being higher than the second priority of the second terminal function, continuing execution of the first terminal function by the target driver module;
in response to the second priority of the second terminal function being higher than the first priority of the first terminal function, stopping the execution of the first terminal function and executing the second terminal function through the target driver module.

In some embodiments, an order of the first priority and the second priority can be determined based on the priority relationship between the first terminal function and the second terminal function. For example, the priority relationship can be priorities of multiple terminal functions arranged in order of priority from low to high or from high to low.

In some embodiments, stopping the execution of the first terminal function and executing the second terminal function through the target driver module can include: stopping the execution of the first terminal function, determining a driving parameter corresponding to the execution of the second terminal function, and executing the second terminal function through the target driver module based on the driving parameter.

In some embodiments, the driving parameter can include the parameter required for the execution of the second terminal function by the target driver module, such as a voltage parameter, a current parameter, or a power parameter.

In some embodiments, executing the second terminal function through the target driver module based on the driving parameter can include executing the second terminal function based on the driving parameter after the target driver module is initialized. For example, the second terminal function is executed through the target driver module after the voltage of the target driver module is initialized.

In some embodiments, the method further includes: in response to the execution of the second terminal function being completed, restoring the execution of the first terminal function through the target driver module.

In some embodiments, if the priority of the second terminal function is higher than the priority of the first terminal function, the target driver module stops the execution of the first terminal function and switches to the execution of the second terminal function. After the execution of the second terminal function is completed, the target driver module can switch back to the execution of the first terminal function.

In some embodiments, if the execution of the second terminal function is completed, whether the first terminal function meets an execution condition is determined. If the first terminal function meets the execution condition, the execution of the first terminal function will be restored through the target driver module. In some embodiments, the execution condition can indicate that the first terminal function can be continued to be executed. For example, when the first terminal function is the wireless reverse charging function, the execution condition can indicate that the device needing to be charged using the wireless reverse charging is still connected to the terminal.

In some embodiments, restoring the execution of the first terminal function through the target driver module can include determining the driving parameter corresponding to the execution of the first terminal function, and restoring the execution of the first terminal function through the target driver module based on the driving parameter.

In some embodiments, the driving parameter can include the parameter required for the execution of the first terminal function by the target driver module. For example, the driving parameter can be recorded and saved when the execution of the first terminal function is stopped.

In some embodiments, restoring the execution of the first terminal function through the target driver module based on the driving parameter can include restoring, after the target driver module is initialized, the execution of the first terminal function through the target driver module based on the driving parameter. For example, the first terminal function is executed through the target driver module after the voltage of the target driver module is initialized.

In this way, after the execution process of the first terminal function is interrupted and the execution of the second terminal function is completed, the previously interrupted execution process of the first terminal function can be continued. As a result, the intelligence and flexibility in function conversion of the target drive module is further enhanced and the success rate in execution of the terminal function is improved.

In some embodiments, the method further includes following steps:
an alternative execution mode corresponding to a terminal function out of the at least two terminal functions that is not executed by the target driver module is obtained;
the terminal function that is not executed by the target driver module is executed based on the alternative execution mode.

In some embodiments, the alternative execution mode can be an execution mode associated with the terminal function that can be executed by another driver module. For example, when the terminal function is the vibration function for reminder, the alternative execution mode can be a lighten-on screen, a flashing flash lamp, etc.

In some embodiments, the alternative execution mode can be obtained through the historical execution records or function information of the respective terminal function in the terminal. For example, the function information can be information that records multiple execution modes of the terminal function.

In some embodiments, the method can further include: if the alternative execution mode needs to be realized using the target driver module, stopping the execution of the terminal function that is not executed by the target driver module, or outputting reminder information associated with the terminal function that is not executed by the target driver module. In some embodiments, outputting the reminder information associated with the terminal function that is not executed by the target driver module can include displaying on the screen the reminder information associated with the indication content of the terminal function that is not executed by the target driver module.

In this way, through the alternative execution mode, the terminal function with the lower priority can be better executed when the target driver module is executing the terminal function with the higher priority, thereby reducing the poor terminal availability due to the inability of the terminal function to be executed.

In some embodiments, determining the priority relationship of the at least two terminal functions can include: obtaining the priority relationship of the at least two terminal functions preset in the terminal, or determining the priority relationship of the at least two terminal functions based on historical execution records of the at least two terminal functions.

In some embodiments, the priority relationship preset in the terminal can be a priority relationship pre-selected or -set by the user, or a priority relationship pre-stored in the terminal.

In some embodiments, the priority relationship pre-set in the terminal can be function description information of the multiple terminal functions output to the user, and by means of the function description information, the priority relationship corresponding to the multiple terminal functions set by the user is obtained. For example, the function description information of the wireless reverse charging function and the vibration function is output to the user, and the priority relationship that “the wireless reverse charging function has priority over the vibration function” set by the user is obtained, etc.

In some embodiments, the priority relationship of the at least two terminal functions is determined based on the historical execution records of the at least two terminal functions, which can include determining the priority relationship of the at least two terminal functions based on the historical execution records (of the at least two terminal functions) within a preset time period. For example, the priority relationship between the wireless reverse charging function and the vibration function can be determined based on the historical execution records of the wireless reverse charging function and the vibration function in the terminal recorded within 3 days.

In some embodiments, the priority relationship can be determined based on the execution frequency, the execution duration of the present terminal function recorded in the historical execution records, or the execution order between the present terminal function and other terminal functions.

In some embodiments, the terminal function can include at least one of the following: a wireless charging function, a motor driving function, and an OTG function for data exchange.

In some embodiments, that one terminal function out of the at least two terminal functions is executed through the target driver module includes: outputting prompt information indicating the execution of a target terminal function out of the at least two terminal functions, and in response to detection of a preset operation corresponding to the prompt information, executing the target terminal function through the target driver module.

In some embodiments, the prompt information can be a prompt for the user to select one target terminal function from the at least two terminal functions, or a prompt for the user to perform a corresponding operation after determining the target terminal function.

In some embodiments, the preset operation corresponding to the prompt information can be a selection operation for the user to select the target terminal function, or an operation performed by the user to execute the target terminal function. For example, the preset operation can include deactivating the terminal function that is being executed by the target driver module and establishing the connection between the device corresponding to the target terminal function and the terminal.

In some embodiments, during the execution of the wireless reverse charging function by the target driver module, if the operational command for the OTG function is detected and it is determined that the OTG function is the target terminal function, the output prompt information can be “Please turn off reverse charging and insert OTG device”. After detecting that the wireless reverse charging has been shut down and the OTG device has been inserted, the OTG function is executed through the target driver module.

In some embodiments, during the execution of the OTG function by the target driver module, if the operational command for the wireless reverse charging function is detected and it is determined that the wireless reverse charging function is the target terminal function, the output prompt information can be “Please remove OTG device and turn on reverse charging”. After detecting that the OTG device has been removed and the connection with the wireless reverse charging device has been established, the wireless reverse charging function is executed through the target driver module.

In some embodiments, the method can further include: in response to no preset operations being detected, continuing the execution of the terminal function currently being executed by the target driver module, or keeping the target driver module in the idle state, etc.

In this way, by means of the prompt information output and the preset operation detection, the user's participation in the execution process of the terminal function can be further improved, reducing the usability gap caused by the mismatch between the execution of the terminal function and the user's intention.

In some embodiments, the terminal function can include the wireless charging function, the motor driving function, and the OTG function, then the step S130 can include following steps.

When the wireless charging function is currently being executed through the target driver module, based on the priority relationship, the wireless charging function is continued to be executed through the target driver module, or the execution of the wireless charging function is stopped, and the motor driving function or the OTG function is executed through the target driver module.

Additionally and alternatively (and/or), when the OTG function is currently being executed through the target driver module, based on the priority relationship, the OTG function is continued to be executed through the target driver module, or the execution of the OTG function is stopped, and the wireless charging function or the motor driving function is executed through the target driver module.

Additionally and alternatively (and/or), when the motor driving function is currently being executed through the target driver module, based on the priority relationship, the motor driving function is continued to be executed through the target driver module, or the execution of the motor driving function is stopped, and the wireless charging function or the OTG function is executed through the target driver module.

In some embodiments, the target driver module can detect the operational command indicating the execution of another terminal function when executing one terminal function. The target driver module then determines whether to continue the execution of the terminal function currently being executed, or to stop the execution of the terminal function currently being executed and execute another terminal function based on the priority relationship between the two terminal functions.

In some embodiments, the operational command indicating the execution of the second terminal function is detected when the first terminal function is currently being executed. If the priority of the first terminal function is higher than the priority of the second terminal function, the execution of the first terminal function will be continued. If the priority of the first terminal function is lower than the priority of the second terminal function, the execution of the first terminal function will be stopped and the second terminal function will be executed through the target driver module.

In some embodiments, the first terminal function can be one of the wireless charging function, the motor driving function, or the OTG function, and the second terminal function can be any of the wireless charging function, the motor driving function, or the OTG function that is different from the first terminal function.

It should be noted that those skilled in the art can understand that the methods provided in embodiments of the present disclosure can be performed separately or together with some methods in embodiments of the present disclosure or in related technologies.

In order to better understand the embodiments of the present disclosure, the technical solutions of the present disclosure will be further explained in the following based on some examples.

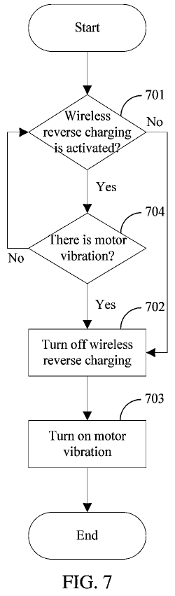

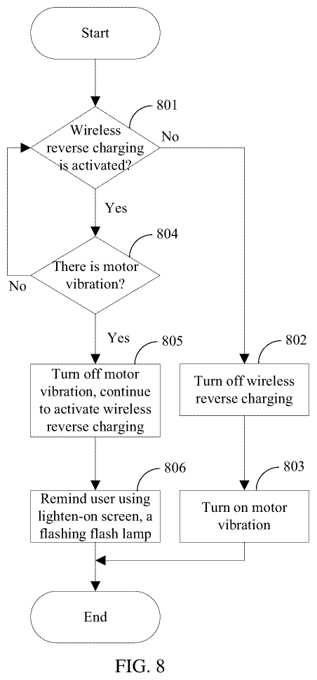

As shown in FIG. 6, embodiments of the present disclosure provide a terminal control method based on a target driver module, which can execute functions as shown in FIGS. 7 and 8.

As shown in FIG. 7, when the terminal needs to execute the motor vibration function, the system first determines whether the wireless reverse charging function is activated (701). If the wireless reverse charging function is not activated, the wireless reverse charging function can be directly turned off (702) and the motor vibration function is then turned on (703). If the wireless reverse charging function is currently being executed by the terminal, the wireless reverse charging function needs to be turned off temporarily and the motor vibration function is turned on. After the execution of the vibration function is completed, the system turns off the motor and turns on the wireless reverse charging function. In the case where the wireless reverse charging function is activated, the system can monitor the motor vibration function by circularly determining whether the wireless reverse charging function is activated and whether there is motor vibration function (704).

As shown in FIG. 8, in the case where the wireless reverse charging function has a higher priority than the motor vibration function, when the terminal needs to execute the motor vibration function, the system first determines whether the wireless reverse charging function is activated (801). If the wireless reverse charging function is not activated, the wireless reverse charging function can be directly turned off (802) and the motor vibration function is then turned on (803). If the wireless reverse charging function is currently being executed by the terminal, the wireless reverse charging function is continued to be maintained and the motor vibration function is turned off (805). The terminal then reminds (806) the user by lightening the screen and flashing the flash lamp at the same time. In the case where the wireless reverse charging function is activated, the system can monitor the motor vibration function by circularly determining whether the wireless reverse charging function is activated and whether there is motor vibration function (804).

In some embodiments, all terminal functions are powered through the power supply Boost of the motor, but multiple of the terminal functions cannot be executed simultaneously. The terminal functions involved include motor vibration, wireless reverse charging, and OTG.

In some embodiments, the terminal first provides wireless reverse charging, and then needs to vibrate.

Due to the limited power supply capacity of the Boost, it cannot supply power for both the wireless reverse charging and the motor at the same time. Therefore, the terminal will first stop the wireless reverse charging, then initialize the boost voltage to allow the motor to work, and then turn on the wireless reverse charging after the motor stops, to supply power for the wireless reverse charging.

In some embodiments, the terminal first provides wireless reverse charging, and then an OTG device is plugged in.

When it is detected that the terminal is already in a reverse charging state and there is an OTG device to be plugged in, due to the limited power supply capacity of the Boost, it cannot supply power for both terminal functions at the same time, prompt information “Please turn off reverse charging before insert OTG device” will be displayed on the terminal interface.

In some embodiments, the terminal first provides the OTG function, and then the wireless reverse charging.

The terminal is detected to be already in an OTG state, when the button is clicked to execute the wireless reverse charging function. Due to the limited power supply capacity of the Boost, it cannot supply power for both terminal functions at the same time, prompt information “Please remove OTG device before turn on reverse charging” will be displayed on the terminal interface.

It should be noted that those skilled in the art can understand that methods provided in embodiments of the present disclosure can be performed separately or together with some methods in embodiments of the present disclosure or in related technologies.

As shown in FIG. 9, embodiments of the present disclosure provide a terminal control apparatus, and the apparatus can include an obtaining unit 10, a determination unit 20, and an execution unit 30.

The obtaining unit 10 is configured to obtain multiple terminal functions supported by a target driver module in a terminal.

The determination unit 20 is configured to determine, in response to detection of an operational command indicating at least two terminal functions, a priority relationship of the at least two terminal functions.

The execution unit 30 is configured to execute, based on the priority relationship, one terminal function out of the at least two terminal functions through the target driver module.

In some embodiments, the determination unit 20 is configured to determine, in response to the detection of the operational command indicating the at least two terminal functions when the target driver module is in an idle state, the priority relationship of the at least two terminal functions.

In some embodiments, the determination unit 20 is configured to execute, in response to detection of a first operational command indicating a first terminal function when the target driver module is in the idle state, the first terminal function through the target driver module; and determine, in response to detection of a second operational command indicating a second terminal function during execution of the first terminal function, the priority relationship of the first terminal function and the second terminal function.

In some embodiments, the execution unit 30 is configured to continue, in response to a first priority of the first terminal function being higher than a second priority of the second terminal function, the execution of the first terminal function through the target driver module; or stop, in response to the second priority of the second terminal function being higher than the first priority of the first terminal function, the execution of the first terminal function, and execute the second terminal function through the target driver module.

In some embodiments, the execution unit 30 is further configured to restore, in response to execution of the second terminal function being completed, the execution of the first terminal function through the target driver module.

In some embodiments, the apparatus can further include a switching unit configured to obtain an alternative execution mode corresponding to a terminal function that is not executed by the target driver module out of the at least two terminal functions, and execute, based on the alternative execution mode, the terminal function that is not executed by the target driver module.

In some embodiments, the determination unit 20 is configured to obtain the priority relationship of the at least two terminal functions preset in the terminal; or determine the priority relationship of the at least two terminal functions based on historical execution records of the at least two terminal functions.

In some embodiments, the execution unit 30 is configured to output prompt information indicating execution of a target terminal function out of the at least two terminal functions; and execute, in response to detection of a preset operation corresponding to the prompt information, the target terminal function through the target driver module.

In some embodiments, the terminal function includes the wireless charging function, the motor driving function, and the OTG function. Then the execution unit 30 is configured to: when the target driver module is currently executing the wireless charging function and based on the priority relationship, continue execution of the wireless charging function, or stop the execution of the wireless charging function and execute the motor driving function or the OTG function through the target driver module; and/or when the target driver module is currently executing the OTG function and based on the priority relationship, continue execution of the OTG function, or stop the execution of the OTG function and execute the wireless reverse charging function through the target driver module.

The specific ways in which each module in the apparatus provided in the above embodiments performs operations have been described in detail in relevant method embodiments, which will not be repeated here.

Embodiments of the present disclosure provide a communication device. The communication device includes a processor and a memory used to store instructions executable by the processor. The processor is connected to the memory.

In some embodiments, the processor is configured to execute the instructions to cause the terminal control method provided in any of aforementioned embodiments of the present disclosure to be implemented.

The processor can include various types of storage media. The storage media are non-transitory computer storage media that can continue to remember information stored thereon after the communication device is powered down.

In some embodiments, the communication device includes the terminal or the network element.

The processor can be connected to the memory through a bus or other means to read executable programs stored on the memory, for example, at least one of the methods shown in FIG. 2, 4 or 5.

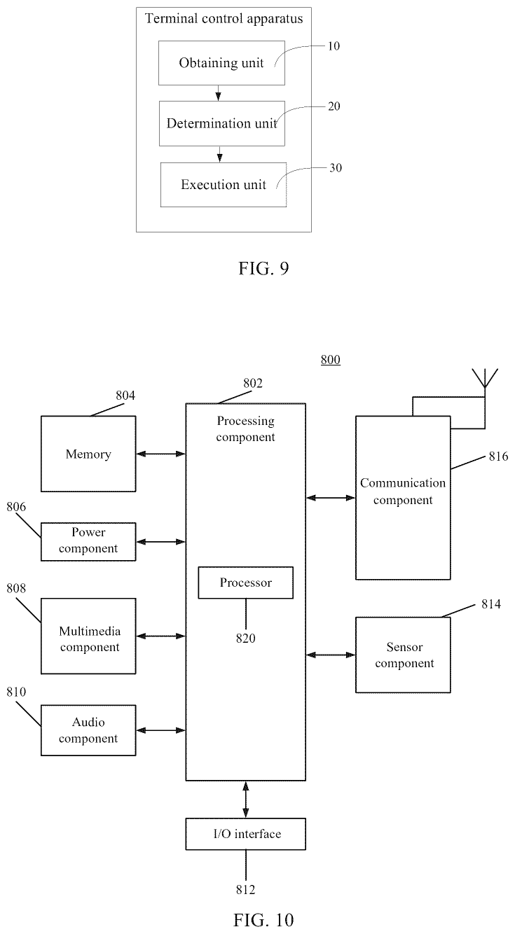

FIG. 10 is a block diagram of a terminal 800 according to embodiments of the present disclosure. For example, the terminal 800 can be a mobile phone, a computer, a digital broadcasting user device, a messaging device, a game console, a tablet device, a medical device, a fitness device, a personal digital assistant, etc.

As shown in FIG. 10, the terminal 800 can include one or more of the following components: a processing component 802, a memory 804, a power component 806, a multimedia component 808, an audio component 810, an input/output (I/O) interface 812, a sensor component 814, and a communication component 816.

The processing component 802 typically controls the overall operation of the terminal 800, such as operations associated with display, telephone call, data communication, camera operation, and recording operations. The processing component 802 may include one or more processors to execute instructions to complete all or part of the methods described above. In addition, the processing component 802 may include one or more modules to facilitate interactions between the processing component 802 and other components. For example, the processing component 802 may include a multimedia module to facilitate interaction between the multimedia component 808 and the processing component 802.

The memory 804 is configured to store various types of data to support operations in the terminal 800. Examples of such data include instructions, contact data, phone book data, messages, pictures, videos, and the like for any application or method operating on the terminal 800. The memory 804 can be implemented by any type of volatile or non-volatile storage device or their combination, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or optical disk.

The power component 806 provides power for various components of the terminal 800. The power component 806 may include a power management system, one or more power supplies, and other components associated with generating, managing, and distributing power for the terminal 800.

The multimedia component 808 includes a display screen providing an output interface between the terminal 800 and the user. In some embodiments, the screen may include a liquid crystal display (LCD) and a touch panel (TP). If the screen includes a touch panel, the screen can be implemented as a touch screen to receive input signals from the user. The touch panel includes one or more touch sensors to sense touch, sliding, and gestures on the touch panel. The touch sensor can not only sense the boundaries of touch or sliding actions, but also detect the duration and pressure related to the touch or sliding operation. In some embodiments, the multimedia component 808 includes a front camera and/or a rear camera. When the terminal 800 is in operation mode, such as shooting mode or video mode, the front camera and/or rear camera can receive external multimedia data. Each front camera and rear camera can be a fixed optical lens system or have focal length and optical zoom capability.

The audio component 810 is configured to output and/or input audio signals. For example, the audio component 810 includes a microphone (MIC), which is configured to receive an external audio signal when the terminal 800 is in an operation mode, such as a calling mode, a recording mode, and a voice recognition mode. The received audio signal may be further stored in memory 804 or transmitted via communication component 816. In some embodiments, the audio component 810 also includes a speaker for outputting audio signals.

The I/O interface 812 provides an interface between the processing component 802 and peripheral interface modules, which can be a keyboard, click wheel, button, etc. These buttons may include, but are not limited to, the Home button, Volume button, Start button, and Lock button.

The sensor component 814 includes one or more sensors for providing various aspects of condition evaluation for the terminal 800. For example, the sensor component 814 can detect an open/closed state of the terminal 800, relative positioning of the components. The component is, for example, a display and a keypad of the terminal 800. The sensor component 814 can also detect changes in the position of the terminal 800 or one component of the terminal 800, presence or absence of the user's contact with the terminal 800, orientation or acceleration/deceleration of the terminal 800 and temperature change of the terminal 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an acceleration sensor, a gyroscope sensor, a magnetic sensor, a pressure sensor, or a temperature sensor.

The communication component 816 is configured to facilitate wired or wireless communication between the terminal 800 and other devices. The terminal 800 can access wireless networks based on communication standards, such as WiFi, 2G or 3G, or a combination thereof. In some embodiments, the communication component 816 receives a broadcast signal or broadcast related information from an external broadcast management system via a broadcast channel. In some embodiments, the communication component 816 also includes a near field communication (NFC) module to facilitate short range communication. For example, the NFC module can be implemented based on radio frequency identification (RFID) technology, infrared data association (IrDA) technology, ultra wideband (UWB) technology, Bluetooth (BT) technology and other technologies.

In some embodiments, the terminal 800 can be implemented through one or more application specific integrated circuits (ASIC), digital signal processors (DSP), digital signal processing devices (DSPD), programmable logic devices (PLD), field programmable gate arrays (FPGA), controllers, microcontrollers, microprocessors, or other electronic components, for implementing above methods.

In some embodiments, a non-transitory computer-readable storage medium including instructions is also provided, such as a memory 804 including instructions, which can be executed by a processor of the terminal 800 to complete above methods. For example, the non-transitory computer-readable storage medium can be ROM, random access memory (RAM), CD-ROM, tapes, floppy disks, optical data storage devices, etc.

After considering the specification and practices of the invention disclosed herein, those skilled in the art will easily come up with other implementation solutions of the present disclosure. The present disclosure aims to cover any variations, uses, or adaptive changes of the present disclosure, which follow the general principles of the present disclosure and include common knowledge or commonly used technical means in the art that are not disclosed in the present disclosure. The specification and embodiments are only considered exemplary, and the true scope and spirit of the present disclosure are defined by appended claims.

In some cases, any two of the above technical features can be combined into a new technical solution of a method without conflict.

In some cases, any two of the above technical features can be combined into a new technology solution of an apparatus without conflict.

It should be understood that embodiments of the present disclosure are not limited to the precise structure described above and shown in the drawings, and various modifications and changes can be made without departing from its scope. The scope of the present disclosure is limited only by the appended claims.

1. A terminal control method, comprising:
obtaining multiple terminal functions supported by a target driver module in a terminal;
determining, in response to detection of an operational command indicating at least two terminal functions, a priority relationship of the at least two terminal functions; and
executing, based on the priority relationship, one terminal function out of the at least two terminal functions through the target driver module.

2. The method according to claim 1, wherein determining, in response to the detection of the operational command indicating the at least two terminal functions, the priority relationship of the at least two terminal functions, comprises:
determining, in response to the detection of the operational command indicating the at least two terminal functions when the target driver module is in an idle state, the priority relationship of the at least two terminal functions.

3. The method according to claim 2, wherein determining, in response to the detection of the operational command indicating the at least two terminal functions when the target driver module is in the idle state, the priority relationship of the at least two terminal functions, comprises:
executing, in response to detection of a first operational command indicating a first terminal function when the target driver module is in the idle state, the first terminal function through the target driver module; and
determining, in response to detection of a second operational command indicating a second terminal function during execution of the first terminal function, the priority relationship of the first terminal function and the second terminal function.

4. The method according to claim 3, wherein executing, based on the priority relationship, one terminal function out of the at least two terminal functions through the target driver module, comprises:
continuing, in response to a first priority of the first terminal function being higher than a second priority of the second terminal function, the execution of the first terminal function through the target driver module; or
stopping, in response to the second priority of the second terminal function being higher than the first priority of the first terminal function, the execution of the first terminal function, and executing the second terminal function through the target driver module.

5. The method according to claim 4, further comprising:
restoring, in response to execution of the second terminal function being completed, the execution of the first terminal function through the target driver module.

6. The method according to claim 1, further comprising:
obtaining an alternative execution mode corresponding to a terminal function that is not executed by the target driver module out of the at least two terminal functions; and
executing, based on the alternative execution mode, the terminal function that is not executed by the target driver module.

7. The method according to claim 1, wherein determining the priority relationship of the at least two terminal functions, comprises one of:
obtaining the priority relationship of the at least two terminal functions preset in the terminal; or
determining the priority relationship of the at least two terminal functions based on historical execution records of the at least two terminal functions.

8. The method according to claim 1, wherein the terminal function comprises at least one of a wireless charging function, a motor driving function, or an On-The-Go (OTG) function for data exchange.

9. The method according to claim 1, wherein executing one terminal function out of the at least two terminal functions through the target driver module, comprises:
outputting prompt information indicating execution of a target terminal function out of the at least two terminal functions; and
executing, in response to detection of a preset operation corresponding to the prompt information, the target terminal function through the target driver module.

10. The method according to claim 1, wherein the terminal function comprises a wireless charging function, a motor driving function, and an On-The-Go (OTG) function; and
when the target driver module is currently executing the wireless charging function, executing, based on the priority relationship, one terminal function out of the at least two terminal functions through the target driver module, comprises one of:
continuing execution of the wireless charging function, or
stopping the execution of the wireless charging function and executing the motor driving function or the OTG function through the target driver module.

11.-19. (canceled)

20. A communication device, comprising:
a processor; and
a memory storing a program executable by the processor,
wherein the processor is configured to:
obtain multiple terminal functions supported by a target driver module in a terminal;
determine, in response to detection of an operational command indicating at least two terminal functions, a priority relationship of the at least two terminal functions; and
execute, based on the priority relationship, one terminal function out of the at least two terminal functions through the target driver module.

21. A non-transitory computer-readable storage medium having a program stored thereon, wherein when the program is executed by a processor, the processor is caused to perform a terminal control method comprising:
obtaining multiple terminal functions supported by a target driver module in a terminal;
determining, in response to detection of an operational command indicating at least two terminal functions, a priority relationship of the at least two terminal functions; and
executing, based on the priority relationship, one terminal function out of the at least two terminal functions through the target driver module.

22. The method according to claim 3, wherein determining, in response to the detection of the second operational command indicating the second terminal function during the execution of the first terminal function, the priority relationship of the first terminal function and the second terminal function, comprises:
determining, in response to the detection of the second operational command indicating the second terminal function during the execution of the first terminal function, a remaining duration for completing the execution of the first terminal function execution; and
determining, in response to the remaining duration being greater than a preset threshold, the priority relationship of the first terminal function and the second terminal function.

23. The method according to claim 22, further comprising:
executing, in response to the remaining duration being lower than or equal to the preset threshold, the second terminal function through the target driver module after the execution of the first terminal function is completed or after the remaining duration.

24. The method according to claim 4, wherein executing the second terminal function through the target driver module, comprises:
determining a driving parameter corresponding to execution of the second terminal function; and
executing the second terminal function through the target driver module based on the driving parameter.

25. The method according to claim 24, wherein the driving parameter comprises at least one of a voltage parameter, a current parameter, or a power parameter.

26. The method according to claim 5, wherein restoring, in response to the execution of the second terminal function being completed, the execution of the first terminal function through the target driver module, comprises:
determining, in response to the execution of the second terminal function being completed, whether the first terminal function meets an execution condition; and
restoring, in response to the first terminal function meeting the execution condition, the execution of the first terminal function through the target driver module.

27. The method according to claim 26, wherein restoring the execution of the first terminal function through the target driver module, comprises:
determining a driving parameter corresponding to the execution of the first terminal function; and
restoring the execution of the first terminal function through the target driver module based on the driving parameter.

28. The method according to claim 1, wherein the terminal function comprises a wireless charging function, a motor driving function, and an On-The-Go (OTG) function; and
when the target driver module is currently executing the OTG function, executing, based on the priority relationship, one terminal function out of the at least two terminal functions through the target driver module, comprises one of:
continuing execution of the OTG function, or
stopping the execution of the OTG function and executing the wireless charging function or the motor driving function through the target driver module.

29. The method according to claim 1, wherein the terminal function comprises a wireless charging function, a motor driving function, and an On-The-Go (OTG) function; and
when the target driver module is currently executing the motor driving function, executing, based on the priority relationship, one terminal function out of the at least two terminal functions through the target driver module, comprises one of:
continuing execution of the motor driving function, or
stopping the execution of the motor driving function and executing the wireless charging function or the OTG function through the target driver module.
